(19) United States
(12) Patent Application Publication
(10) Pub. No.: US 2006/0141886 A1
(43) Pub. Date: Jun. 29, 2006

(54) Spunbond-meltblown-spunbond laminates made from biconstituent meltblown materials

(76) Inventors: Thomas W. Brock, Woodstock, GA (US); Mark G. Cupta, Atlanta, GA (US); Brian S. Forbes, Alpharetta, GA (US); John J. Lassig, Cumming, GA (US); Vicky S. Smith, Roswell, GA (US)

Correspondence Address: Maxwell J. Petersen;Pauley Petersen & Erickson, Suite 365, 2800 West Higgins Road, Hoffman Estates, IL, 60195, US

(21) Appl. No.: 11/025,180

(22) Filed: Dec. 29, 2004

(51) Int. Cl. B32B 5/26; D04H 1/56; D04H 3/16

(52) U.S. Cl. 442/382; 442/381; 442/400; 442/401

(57) ABSTRACT

Spunbond-meltblown-spunbond nonwoven fabrics having good softness, drape and extensibility, in addition to strength and barrier, are formed from combinations of bicomponent spunbond fibers having low fiber denier and biconstituent meltblown fibers. The spunbond fibers include an outer sheath portion formed using a first polyolefin and an inner core portion formed using a second polyolefin or polyester. The meltblown fibers include first meltblown fibers formed using a polyolefin and second meltblown fibers formed using a polyester.

### BACKGROUND OF THE INVENTION

This invention is directed to spunbond-meltblown-spunbond (“SMS”) laminates having a good softness, drape and extensibility, in addition to strength and barrier.

SMS laminates are disclosed in U.S. Pat. No. 4,041,203 to Brock et al. The laminates disclosed in Brock et al. contain two outer thermoplastic spunbond layers having an average filament diameter in excess of 12 microns, and an inner thermoplastic meltblown layer having an average fiber diameter up to 10 microns. The layers are positioned in a laminar surface-to-surface relationship and united together at intermittent discrete bond regions formed by the application of heat and pressure to provide a unitary structure. The laminates have a desirable textile-like appearance and drape characteristics, load bearing and bacterial barrier properties, and allow sterilant penetration.

SMS laminates have since been-disclosed in which some or all of the layers are formed using bicomponent filaments or fibers. Such laminates are disclosed in U.S. Pat. No. 6,776,858 to Bansal et al.; U.S. Pat. No. 6,723,669 to Clark et al.; and U.S. Publication 2004/0192146 to Sturgill II, for instance. There is a demand for SMS laminates having improved fabric properties, in addition to strength and barrier.

### SUMMARY OF THE INVENTION

The invention is directed to a nonwoven fabric, specifically a SMS laminate, including:

a) an inner layer of biconstituent meltblown fibers including about 25-85% by weight of first fibers including at least 50% by weight polyolefin and about 15-75% by weight of second fibers including at least 50% by weight polyester; and

b) two outer layers of bicomponent spunbond fibers having a fiber denier of not more than about 1.1, the spunbond fibers including an outer sheath including at least 50% weight of a first polyolefin and an inner core including at least 50% by weight of a second polyolefin or a polyester.

In one embodiment, the fine bicomponent spunbond fibers include an outer sheath formed of a random propylene-ethylene copolymer containing up to 10% by weight ethylene, and an inner core formed of polypropylene homopolymer. The biconstituent meltblown fibers include first fibers formed of polypropylene and second fibers formed of polybutylene terephthalate.

In another embodiment, the fine bicomponent spunbond fibers include an outer sheath of polyethylene and an inner core of polyethylene terephthalate. The biconstituent meltblown fibers include first fibers formed of polyethylene and second fibers formed of polyethylene terephthalate.

The above combinations of fine bicomponent fiber spunbond layers and a biconstituent fiber meltblown layer produce SMS fabrics with improved strength, barrier, softness and extension properties. The fine bicomponent fiber spunbond layers contribute to improved strength, softness, and drape. The combination contributes to barrier and extension properties.

### BRIEF DESCRIPTION OF THE DRAWINGS

FIG. 1 is a schematic fragmentary perspective view of a SMS material, with sections broken away to reveal all of the layers.

FIGS. 2A and 2B illustrate sectional views of different embodiments of a sheath-core bicomponent fiber, which can be employed in the spunbond layers of the inventive SMS laminate.

FIG. 3 illustrates a sectional view of first and second meltblown fibers having different polymer compositions, which can be employed in the meltblown layer of the inventive SMS laminate.

FIG. 4 is an enlarged sectional view showing a bond point 56 of FIG. 1.

FIG. 5 schematically illustrates a process for preparing a SMS laminate of the invention.

### DEFINITIONS

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns (μm). (Note that to convert from osy to gsm, multiply osy by 33.91).

As used herein, “denier” refers to the weight in grams per 9000 meters of an individual filament or fiber.

As used herein the term “spunbond fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartman; and U.S. Pat. No. 3,542,615 to Dobo et al. Spunbond fibers are generally not tacky when they are deposited onto a collecting surface. Spunbond fibers are generally continuous.

As used herein the term “meltblown fibers” means fibers formed by extruding a molten thermoplastic material through a plurality of fine, usually circular, die capillaries as molten threads or filaments into converging high velocity, usually hot, gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin et al. Meltblown fibers are microfibers which may be continuous or discontinuous, and are generally tacky when deposited onto a collecting surface. “First” meltblown fibers and “second” meltblown fibers refer to meltblown fibers having different polymer compositions.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers that have been formed from at least two component polymers, or the same polymer with different properties or additives, extruded from separate extruders but spun together to form one fiber or filament. Multicomponent fibers are also sometimes referred to as conjugate fibers or bicomponent fibers, although more than two components may be used. The polymers are arranged in substantially constantly positioned distinct zones across the cross-section of the multicomponent fibers and extend continuously along the length of the multicomponent fibers. The configuration of such a multicomponent fiber may be, for example, a concentric or eccentric sheath/core arrangement wherein one polymer is surrounded by another, or may be a side-by-side arrangement, an “islands-in-the-sea” arrangement, or arranged as pie-wedge shapes or as stripes on a round, oval or rectangular cross-section fiber, or other configurations. Multicomponent fibers are taught in U.S. Pat. No. 5,108,820 to Kaneko et al. and U.S. Pat. No. 5,336,552 to Strack et al. Conjugate fibers are also taught in U.S. Pat. No. 5,382,400 to Pike et al. and may be used to produce crimp in the fibers by using the differential rates of expansion and contraction of the two (or more) polymers. For two component fibers, the polymers may be present in ratios of 75/25, 50/50, 25/75 or any other desired ratios. In addition, any given component of a multicomponent fiber may desirably comprise two or more polymers as a multiconstituent blend component.

As used herein, the term “multiconstituent fibers” or “multiconstituent web” refers to a mixture of two or more different fiber types in a single nonwoven web. For instance, multiconstituent meltblown fibers, or a multiconstituent meltblown web, may include a plurality of first meltblown fibers having a first polymer composition and a plurality of second meltblown fibers having a second polymer composition different from the first. Multiconstituent fibers or webs may be referred to as biconstituent fibers or webs where the number of fiber types is two. A suitable process for making multiconstituent meltblown fibers is described in U.S. patent application Ser. No. 10/743,860, filed on 23 Dec. 2003, the disclosure of which is incorporated by reference.

### DETAILED DESCRIPTION OF THE INVENTION

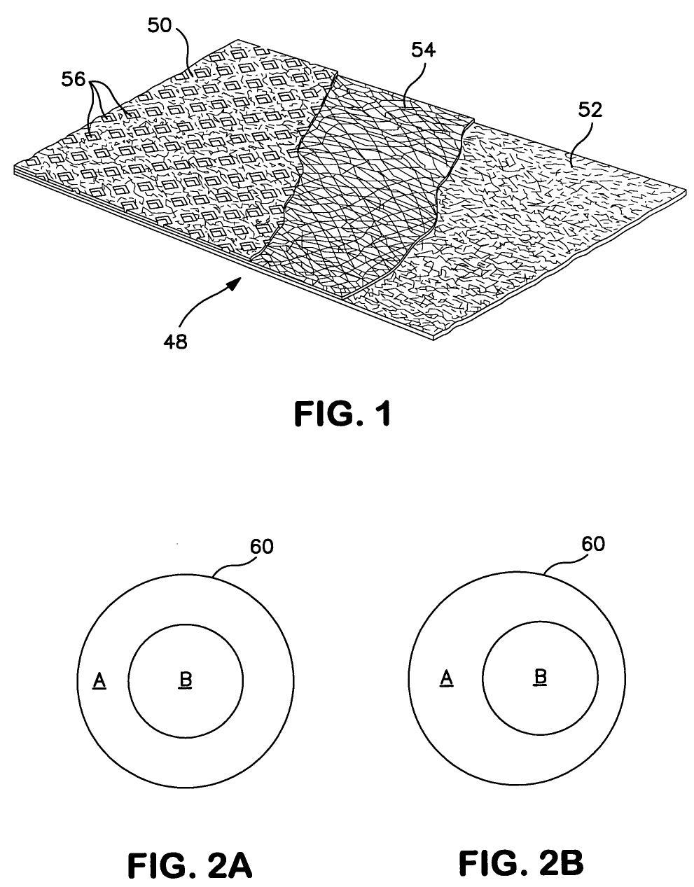

Referring to the drawings, FIG. 1 shows a SMS laminate 48 including top and bottom layers 50 and 52 of substantially continuous and randomly deposited spunbond fibers and a middle layer 54 of meltblown microfibers. The layers are joined together at a plurality of bond points 56.

Referring to FIGS. 2A and 2B, the top and bottom spunbond layers 50 and 52 are formed of fine, sheath-core type bicomponent fibers 60, each having an outer sheath portion A and an inner core portion B. The sheath and core may be concentric as shown in FIG. 2A, or eccentric as shown in FIG. 2B. The sheath portion A and core portion B generally extend the length of each substantially continuous spunbond fiber 60.

The spunbond fibers 60 typically have a circular cross-section, but may have an elliptical, triangular, square, rectangular or other cross-sectional shape. The spunbond fibers 60 are fine, and of small denier, compared to typical spunbond fibers. The spunbond fibers 60 in each layer 50 and 52 may have, on average, a fiber denier of not more than about 1.1, or not more than about 1.0, or not more than about 0.9, or not more than about 0.8, or not more than about 0.7, or not more than about 0.6. The spunbond fibers 60 in each layer 50 and 52 may have, on average, a fiber denier of at least about 0.1, or at least about 0.2, or at least about 0.3, or at least about 0.4, or at least about 0.5.

The outer sheath portion A of each spunbond fiber 60 includes a first polyolefin having a first melting point, as determined by differential scanning calorimetry. Suitable sheath polymers include without limitation branched low density polyethylene homopolymers and copolymers containing up to 20% by weight of an alpha-olefin comonomer having 3-20 carbon atoms; linear low density polyethylene copolymers containing 1-20% by weight of an alpha-olefin comonomer having 3-20 carbon atoms; ethylene-propylene elastomers containing over 10% to less than 80% by weight ethylene and over 20% to less than 90% by weight propylene; propylene-ethylene random copolymers containing up to 10% by weight (suitably 2-8% by weight) ethylene and at least 90% by weight (suitably 92-98% by weight) propylene; other copolymers and terpolymers of ethylene with alpha-olefins having 3-20 carbon atoms; atactic and syndiotactic polypropylene; and combinations thereof. The first polyolefin may be formed using a Ziegler-Natta, single-site or other suitable catalyst, and may have a density of about 0.860 to less than 0.935 grams/cm³. The sheath portion A may include at least 50% by weight of the first polyolefin, or at least 75% by weight, or about 90-100% by weight.

The inner core portion B of each spunbond fiber 60 includes a second polyolefin or polyester having a second melting point higher than the first melting point, as determined by differential scanning calorimetry. Suitable core polymers include without limitation high density polyethylene (typically a linear ethylene homopolymer or ethylene-alpha olefin copolymer having a density of about 0.935-0.965 grams/cm³); substantially isotactic polypropylene (typically a homopolymer having at least about 80% isotacticity); polyethylene terephthalate, polybutylene terephthalate; and combinations thereof. The second polyolefin or polyester may be formed using any suitable catalyst. The inner core portion B may include at least 50% by weight of the second polyolefin or polyester, or at least 75% by weight, or about 90-100% by weight.

In a first embodiment, the sheath portion A of the spunbond fibers 60 is formed of a random propylene-ethylene copolymer containing at least 90% by weight propylene, suitably 92-98% by weight, or 95-97% by weight; and up to 10% by weight ethylene, suitably 2-8% by weight, or 3-5% by weight. The propylene chains are substantially isotactic. The core portion B is formed of substantially isotactic polypropylene homopolymer. In a second embodiment, the sheath portion A of the spunbond fibers 60 is formed of branched or linear low density polyethylene. The core portion B is formed of polyethylene terephthalate.

The spunbond fibers 60 may contain about 10-90% by weight sheath portion A and about 10-90% by weight core portion B, suitably about 20-80% by weight sheath portion A and about 20-80% by weight core portion B, or about 30-70% by weight sheath portion A and about 30-70% by weight core portion B, or about 40-60% by weight sheath portion A and about 40-60% by weight core portion B.

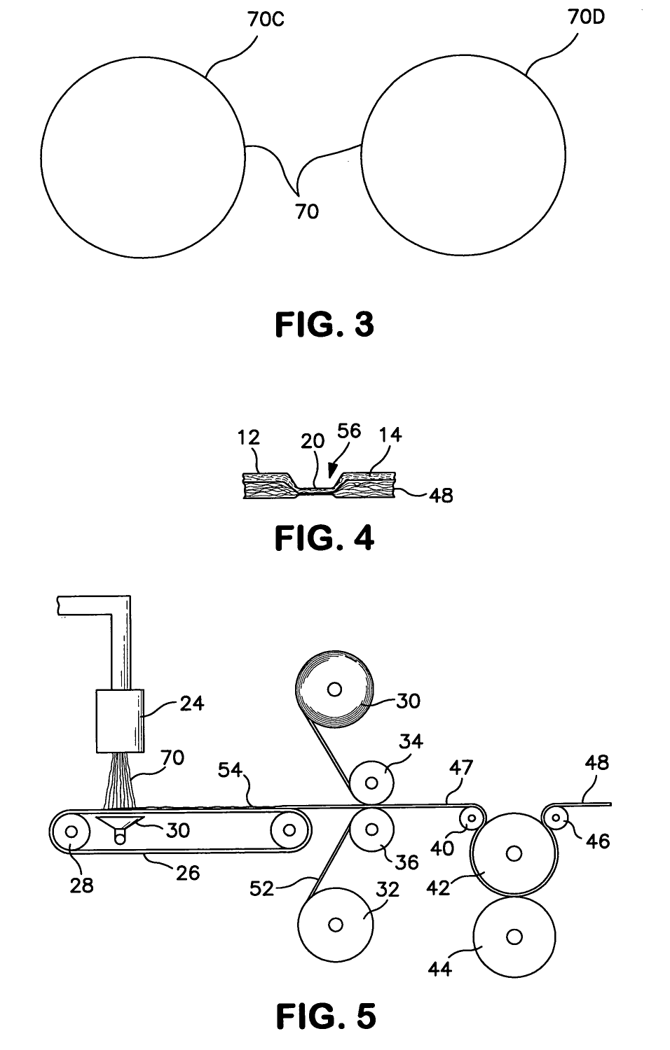

Referring to FIGS. 1 and 3, the middle biconstituent meltblown layer 54 of laminate 48 is formed of meltblown fibers 70 including a plurality of first meltblown fibers 70C and a plurality of second meltblown fibers 70D having different polymer compositions. The meltblown fibers 70 may be generally discontinuous in length, or may be substantially continuous. The meltblown fibers 70 typically have a circular cross-section, but may have an elliptical, triangular, square, rectangular or other cross-sectional shape. The meltblown fibers 70 may have an average fiber denier of not more than about 0.5, or not more than about 0.4, or not more than about 0.3, or not more than about 0.2, or not more than about 0.1. The meltblown fibers 70 may have an average fiber denier of at least about 0.01, or at least about 0.02, or at least about 0.03, or at least about 0.04, or at least about 0.05.

The first meltblown fibers 70C include a polyolefin. Suitable polyolefins include without limitation branched low density homopolymers and copolymers containing up to 20% by weight of an alpha-olefin comonomer having 3-20 carbon atoms; linear low density polyethylene copolymers containing 1-20% by weight of an alpha-olefin comonomer having 3-20 carbon atoms; ethylene-propylene elastomers containing over 10% to less than 80% by weight ethylene and over 20% to less than 90% by weight propylene; propylene-ethylene random copolymers containing up to 10% by weight (suitably 2-8% by weight) ethylene and at least 90% by weight (suitably 92-98% by weight) propylene; other copolymers and terpolymers of ethylene with alpha-olefins having 3-20 carbon atoms; atactic and syndiotactic polypropylene; and combinations thereof. High density polyethylene and substantially isotactic polypropylene may also be suitable in some circumstances. The polyolefin may be produced using a Ziegler-Natta catalyst, a single-site (e.g. metallocene or constrained geometry) catalyst, or any other suitable catalyst. The first meltblown fibers 70C may include at least 50% by weight of the polyolefin, or at least 75% by weight, or about 90-100% by weight.

The second meltblown fibers 70D include a polyester. Suitable polyesters include without limitation polyethylene terephthalate, polybutylene terephthalate (otherwise known as polytetramethylene terephthalate), and combinations thereof, made using any suitable catalyst. The second meltblown fibers 70D may include at least 50% by weight of the polyester, or at least 75% by weight, or about 90-100% by weight.

In a first embodiment, the first meltblown fibers 70C are formed of polypropylene homopolymer or a random propylene-ethylene copolymer containing up to 10% by weight ethylene. The propylene chains in either polymer may be substantially isotactic. The second meltblown fibers 70D are formed of polybutylene terephthalate. In a second embodiment, the first meltblown fibers 70C are formed of branched or linear low density polyethylene. The second meltblown fibers 70D are formed of polyethylene terephthalate.

The meltblown fibers 70 may contain about 25-85% by weight of the first meltblown fibers 70C and about 15-75% by weight of the second meltblown fibers 70D, suitably about 40-80% by weight of the first meltblown fibers 70C and about 20-60% by weight of the second meltblown fibers 70D, or about 50-75% by weight of the first meltblown fibers 70C and about 25-50% by weight of the second meltblown fibers 70D. In the first embodiment described above, meltblown fibers 70 may include about 75% of the first meltblown fibers 70C and about 25% by weight of the second meltblown fibers 70D. In the second embodiment described above, meltblown fibers 70 may include about 50% by weight of the first meltblown fibers 70C and about 50% by weight of the second meltblown fibers 70D.

Depending the end use application, the SMS laminate 48 may have a basis weight of about 10-300 grams per square meter (gsm), or about 15-200 gsm, or about 20-100 gsm, or about 25-50 gsm. Each of the spunbond and meltblown layers 50, 52 and 54 may constitute about 5-60% of the weight of the SMS laminate, or about 15-50% of the weight of the laminate, or about 20-40% of the weight of the laminate, with three layers together constituting 100% of the SMS laminate.

The layers 50, 52 and 54 can be joined together to make the SMS laminate 48 using techniques familiar to persons skilled in the art. One such technique is described in U.S. Pat. No. 4,041,203 which is incorporated by reference. Referring to FIG. 5, the meltblown web 54 is prepared by extruding meltblown polymer fibers 182 from a die 24 onto a forming belt 26 driven by rolls 28. High velocity air, driven in part by suction valve 30, directs the fibers 70 toward the belt 26. Spunbond webs 50 and 52 unwind from rolls 30 and 32 and contact both sides of meltblown web 54 in the vicinity of nip rolls 34 and 36 (which may be heated), whereupon the layers are joined together. The resulting precursor laminate 47 is passed around heated patterned bonding roll 42, aided by guide rolls 40 and 46, and is bonded with the aid of pressure at a nip junctions defined by patterned roll 42 and nip roll 44, to form the SMS laminate 48. Referring to FIG. 4, each of the bond points 56 of SMS laminate 48 has depressed bond regions 20 adjacent to and between raised regions 12 and 14. The spunbond and meltblown layers can be formed and joined using an in-line process as described in U.S. Pat. No. 4,041,203, or any suitable alternative process. Any of the spunbond and meltblown layers may be formed in-line. The layers may be sequentially laid over each other and bonded.

In order to prepare a SMS fabric in the manner illustrated in FIG. 5 which possesses the combination of desirable strength characteristics and textile-like drapability, it is necessary that the spunbond webs 50 and 52 be integrated with the meltblown web 54 without an accompanying adverse effect on the drapability. To this end, it is important that the bonding conditions (temperature, pressure, and to a lesser degree, dwell time in the nip) as well as the pattern of bonding be appropriately selected. An intermittent bond pattern is suitably employed with the pattern being substantially regularly repeating over the surface of the web. The pattern of the raised points on the roll 44 is selected such that the area of the web occupied by the bonds after passage through the nip is about 5-50% of the surface area of the material with the discrete bonds being present in about 50-1000/in.² Suitably, the bonds occupy about 10-30% of the surface area and are present in a density of about 100-500/in.²

Regarding the bonding conditions, the bonding may have the two-fold effect of achieving ply attachment between the three layers and integrating the spunbond webs into the meltblown web so that the resulting material has desirable strength characteristics. It is believed that the illustrated construction containing a meltblown web in laminar contact with two spunbond webs allows the meltblown web to function in this two-fold capacity when at least one polymer of the meltblown web has a lower softening point than at least one polymer of the spunbond webs.

Bonding temperatures and pressures may vary according to the polymers employed in the spunbond and meltblown layers, and may be optimized according to techniques known in the art. Bonding roll temperatures may range from about 90-200° C., or from about 100-180° C., for the materials useful in making the SMS laminates of the invention. Bonding pressure may range from about 3500-35,000 Newtons/cm², suitably about 4000-10,000 Newtons/cm², based on pressures at the high points of the bonding roll 42 in contact with nip roll 44.

### EXAMPLES

### Example 1

A SMS laminate having a basis weight of 62.8 gsm was prepared from two outer spunbond layers composed of 1.0 denier sheath/core bicomponent fibers having an outer sheath of random propylene-ethylene copolymer and an inner core of polypropylene homopolymer, and an inner biconstituent meltblown layer composed of first meltblown fibers of polypropylene homopolymer and second meltblown fibers of polybutylene terephthalate. The bicomponent spunbond fibers contained 50% by weight of random propylene-ethylene copolymer, type 6D43, available from Dow Chemical Co., and 50% by weight of polypropylene homopolymer, type 3155, available from Exxon-Mobil Co. Each spunbond layer constituted 38% by weight of the SMS laminate. The biconstituent meltblown fibers contained 75% by volume of polypropylene homopolymer, type PF-105, available from Basell Co., and 25% by volume of the polybutylene terephthalate, type CELANEX EF-NAT2008, available from Ticona Co. The meltblown layer constituted 24% by weight of the SMS laminate. The SMS layers were bonded together at a temperature of 149° C. and a pin bonding pressure of 55,158 N/cm² to yield a laminate having a wire-weave bond pattern and a bond area covering 17% of the laminate.

The SMS laminate was tested for hydrohead (resistance to water penetration) and tensile strength in the cross direction. The hydrohead resistance was 80.1 mbar. The tensile strength was 12.3 kg.

### Example 2 (Comparative)

A commercial surgical gown sold under the trade name AURORA by Medline Industries of Mundelein, Ill., has a SMS construction with a total basis weight of 64 gsm and a meltblown layer basis weight of 17 gsm. The SMS material is sold under the trade name SUPREL by DuPont Nonwovens Co. of Old Hickory, Tenn. The meltblown layer was formed of side-by-side bicomponent fibers, each fiber having a first polyethylene side and a second polyester side. The spunbond layers were formed of sheath/core bicomponent fibers having an outer polyethylene sheath and an inner polyester core.

The gown material was found to have a hydrohead resistance of 83.5 mbar, and a CD grab peak load (grab tensile strength) of 11.1 kg.

### Test Procedures

Hydrohead: Hydrohead values are measured generally according to the Hydrostatic Pressure Test described in Method 5514 of Federal Test Methods Standard No. 191A, which is equivalent to AATCC Test Method 127-89 and INDA Test Method 80.4-92, and which is incorporated herein by reference. The following additional parameters are pertinent. The hydrohead method utilizes a TEXTEST FX3000 Hydrostatic Head Tester (available from Schmid Corp., Spartanburg, S.C.) filled with purified water and maintained at a temperature between 65° F. and 85° F. (18.3 and 29.4° C.). Under the dynamic conditions, the specimens are subjected to a steadily increasing pressure of the low surface tension liquid. The rate of increase is 60 mbar/minute and the maximum pressure tested is 300 mbar (4 psi). The “strikethrough resistance” is expressed as the pressure when the liquid penetrates the sample. The test is completed after three areas of the fabric have had liquid penetration.

Tensile: The tensile strength of a fabric may be tested as grab tensile strength measuring the cross-directional grab peak load (the maximum load before the specimen ruptures) in accordance with ASTM D5034-90, using rectangular 4-inch by 6-inch (100 mm by 150 mm) specimens. The peak strain as a percentage of specimen extension at rupture may also be recorded.

While the embodiments of the invention described herein are illustrative, various modifications and improvements can be made without departing from the spirit and scope of the invention. The scope of the invention is indicated by the appended claims, and all changes that fall within the meaning and range of equivalents are intended to be embraced therein.

We claim:

1. A nonwoven fabric, comprising:
a) an inner layer of meltblown fibers including about 25-85% by weight first meltblown fibers, the first meltblown fibers including at least 50% by weight polyolefin, and about 15-75% by weight second meltblown fibers, the second meltblown fibers including at least 50% by weight polyester and having a composition different from the first meltblown fibers; and
b) two outer layers of spunbond fibers having an average denier not more than about 1.1, the spunbond fibers including an outer sheath which includes at least 50% by weight of a first polyolefin and an inner core which includes at least 50% by weight of a second polyolefin or a polyester.

2. The nonwoven fabric of claim 1, wherein the first meltblown fibers comprise at least 75% by weight of the polyolefin.

3. The nonwoven fabric of claim 1, wherein the first meltblown fibers comprise about 90-100% by weight of the polyolefin.

4. The nonwoven fabric of claim 1, wherein the polyolefin in the first meltblown fibers comprises a propylene homopolymer or copolymer.

5. The nonwoven fabric of claim 1, wherein the polyolefin in the first meltblown fibers comprises branched or linear low density polyethylene.

6. The nonwoven fabric of claim 1, wherein the second meltblown fibers comprise at least 75% by weight of the polyester.

7. The nonwoven fabric of claim 1, wherein the second meltblown fibers comprise about 90-100% by weight of the polyester.

8. The nonwoven fabric of claim 1, wherein the polyester in the second meltblown fibers comprises polybutylene terephthalate or polyethylene terephthalate.

9. The nonwoven fabric of claim 4, wherein the polyester in the second meltblown fibers comprises polybutylene terephthalate.

10. The nonwoven fabric of claim 5, wherein the polyester in the second meltblown fibers comprises polyethylene terephthalate.

11. The nonwoven fabric of claim 1, wherein the first polyolefin in the sheath of the spunbond fibers comprises a propylene-ethylene copolymer.

12. The nonwoven fabric of claim 11, wherein the core of the spunbond fibers comprises polypropylene.

13. The nonwoven fabric of claim 1, wherein the first polyolefin in the sheath of the spunbond fibers comprises branched or linear low density polyethylene.

14. The nonwoven fabric of claim 13, wherein the core of the spunbond fibers comprises polyethylene terephthalate.

15. A nonwoven fabric, comprising:
a) an inner layer of meltblown fibers including about 25-85% by weight first meltblown fibers, the first meltblown fibers including at least 75% by weight polyolefin, and about 15-75% by weight second meltblown fibers, the second meltblown fibers including at least 75% by weight polyester; and
b) two outer layers of spunbond fibers having an average denier not more than about 1.1, the spunbond fibers including an outer sheath which includes at least 75% by weight of a first polyolefin and an inner core which includes at least 75% by weight of a second polyolefin or a polyester.

16. The nonwoven fabric of claim 15, wherein the inner layer includes about 40-80% by weight of the first meltblown fibers and about 20-60% by weight of the second meltblown fibers.

17. The nonwoven fabric of claim 15, wherein the meltblown fibers include about 50-75% by weight of the first meltblown fibers and about 20-50% by weight of the second meltblown fibers.

18. The nonwoven fabric of claim 15, wherein the spunbond fibers include about 10-90% by weight of the sheath and about 10-90% by weight of the core.

19. The nonwoven fabric of claim 15, wherein the spunbond fibers include about 30-70% by weight of the sheath and about 30-70% by weight of the core.

20. The nonwoven fabric of claim 15, wherein the spunbond fibers have an average denier not more than about 1.0.

21. The nonwoven fabric of claim 15, wherein the spunbond fibers have an average denier not more than about 0.8.

22. A nonwoven fabric, comprising:
a) an inner layer of meltblown fibers including about 40-80% by weight first meltblown fibers, the first meltblown fibers including a polypropylene homopolymer or random propylene-ethylene copolymer, and about 20-60% by weight second meltblown fibers, the second meltblown fibers including polybutylene terephthalate; and
b) two outer layers of spunbond fibers having an average denier not more than about 1.1, the spunbond fibers including about 20-80% by weight of an outer sheath, the outer sheath including a propylene-ethylene copolymer, and about 20-80% by weight of an inner core, the inner core including polypropylene.

23. A nonwoven fabric, comprising:
a) an inner layer of meltblown fibers including about 40-80% by weight first meltblown fibers, the first meltblown fibers including polyethylene, and about 20-60% by weight second meltblown fibers, the second meltblown fibers including polyethylene terephthalate; and
b) two outer layers of spunbond fibers having an average denier not more than about 1.1, the spunbond fibers including about 20-80% by weight of an outer sheath, the outer sheath including polyethylene, and about 20-80% by weight of an inner core, the inner core including polyethylene terephthalate.
